(19) United States
(12) Patent Application Publication
(10) Pub. No.: US 2018/0008494 A1
(43) Pub. Date: Jan. 11, 2018

(54) MEDICAL NURSING PAD FOR PREVENTING BEDSORES

(71) Applicant: BEIJING BEISHUTE MATERNITY & CHILD ARTICLES CO., LTD., Beijing (CN)

(72) Inventor: Qiu-Hong LI, Beijing (CN)

(21) Appl. No.: 15/415,720

(22) Filed: Jan. 25, 2017

(30) Foreign Application Priority Data
Jul. 7, 2016 (CN) 201610532098.4

(51) Int. Cl. A61G 7/057; B68G 7/05; B68G 7/04

(52) U.S. Cl. CPC A61G 7/05792; B68G 7/04; B68G 7/05

(57) ABSTRACT

The present invention provides a medical nursing pad for preventing bedsores. The medical nursing pad comprises a surface layer, a core body layer and a bottom layer. The core body layer has a fluff pulp and a super absorbent polymer material, and is covered by toilet paper. A dotted SAP is distributed on the core body layer. The SAP absorbs and retains an infiltrating liquid in an inversely funnelled SAP absorption region in the core body layer to minimize the reverse osmosis amount of the liquid absorbed by the medical nursing pad. Meanwhile, vapour separated from the liquid reaches the bottom layer through a longitudinal vapour channel formed by a gap among fluff pulp fibres with a certain density range in the core body layer, and is expelled from the medical nursing pad through a nanoscale breathable micro-pore on the bottom layer.

### CROSS-REFERENCE TO RELATED APPLICATION

This application claims priority from China Patent Application No. 201610532098.4, filed on Jul. 7, 2016, in the State Intellectual Property Office of the P.R.C., the content of which are hereby incorporated by reference in their entirety for all purposes.

### BACKGROUND OF THE INVENTION

### 1. Field of the Invention

The present invention belongs to the field of medical nursing articles, and relates to a medical nursing pad capable of effectively preventing bedsores, and specifically to a medical nursing pad, wherein which has an inversely funnelled absorption region is formed in a its core body layer, and a vapour channel is established between core body layers to keep the nursing pad dry, comfortable and breathable, thereby preventing bedsores for bedridden patients.

### 2. Description of the Related Art

For patients with diabetes, cardiovascular disease, renal insufficiency or neurological disorders, the primary disease has been associated with thinning of the skin, decline in metabolic function and impaired reproductive function. If the patients stay in bed for a long time without scientific life care, bedsores will likely be caused.

Bedsores, commonly known as pressure sores, are pressure ulcers occurring on a body part pressed continuously due to hindered blood flow there. They usually occur in paralyzed, unconscious, old and infirm patients who lie in bed or are wheelchair-bound for a long time, and most likely occur on a body part that is pressed, lacking adipose tissue protection, unwrapped with muscle tissues or skeletally protruding with thin muscles.

Bed rest is necessary for patients of most diseases. However, a long-term improper bed rest habit may possibly lead to a big trouble, that is, bedsores. Data shows that among those who are deceased, more than 50% of the bedridden patients die due to a serious infection caused by bedsores, rather than their primary disease. Medical experts warn that when bedridden patients are nursed, care shall be taken to keep their beds smooth and dry. The pressed raised joints of the patients can be supported by a cotton cushion or balloon pad, and local tissues can be free from sustained pressure by regularly massaging these parts and turning the patients. The skin of the patients shall be kept clean and prevented from being scratched. Meanwhile, faeces and urine shall be timely removed to prevent stimulation of the excrement.

As above, the two major causes that the skin ulcerates and bedsores occur lie in that local tissues of the body are pressed and the skin is stimulated by damp for a long time. Therefore, a high quality medical nursing pad is necessary for bedridden patients. To effectively prevent bedsores, the medical nursing pad must be capable of being replaced timely and conveniently and keeping the skin clean and comfortable, and must be dry, comfortable and breathable. To sum up, what the patients need is a medical nursing pad that is small in reverse osmosis amount, rapid to be dry and comfortable and maximally breathable.

The medical nursing pad of the present invention is dry, comfortable and breathable to ensure that the skin of the bedridden patient keeps dry, comfortable and breathable. The dry and comfortable performance of the medical nursing pad is ensured by a small reverse osmosis amount. Meanwhile, expelling vapour from the medical nursing pad needs to be considered to make the medical nursing pad breathable. By combining the dry and comfortable performance and breathability, the medical nursing pad can effectively prevent bedsores. The present invention needs to solve a problem on how to embody the medical nursing pad with these functions.

### SUMMARY OF THE INVENTION

In view of the aforementioned technical problems, the objective of the present invention provides an audio plug detection structure and the method thereof, which can detect whether or not the audio plug is inserted into an audio jack without using an extra connection point.

Medical nursing pads are ideal disposable sanitary products for hospital operations, gynaecological examination, maternity nursing, baby care, defecation and urination of paralyzed patients and women's menstrual period. They are simple to use, sanitary, clean, soft and comfortable, etc., and can keep the user's skin dry and comfortable, prevent bed sheets and mattresses from being contaminated, prevent the possibility of cross infection caused to the user and between users as well as between the user and the nurse, and ease the workload of medical personnel and family members.

The present invention provides a medical nursing pad for preventing bedsores, which is dry, comfortable and breathable. According to the present invention, an inversely funnelled absorption region is formed by a dotted SAP (Super Absorbent Polymer) distributed on a fluff pulp fibre in a core body layer. The SAP is uniformly applied onto the fluff pulp fibre by an SAP applying device. When the SAP is applied onto the fluff pulp fibre, a plurality of inversely funnelled absorption regions are formed, and are compacted by a pressure roller.

The medical nursing pad is provided with the inversely funnelled absorption region, while a fluff pulp fibre not filled with the SAP in the core body layer, having a major function of liquid diversion, forms a diversion region. A liquid spreads all around in the diversion region after the liquid penetrates into the medical nursing pad. As the fluff pulp fibres are transversely arranged, the liquid is transversely diverted all around by the fluff pulp fibres within 360 degrees, thus forming a transverse channel in the core body layer. When the liquid flows into the inversely funnelled absorption region, it is rapidly absorbed and retained by the SAP in the absorption region, thereby achieving the purpose of minimizing the reverse osmosis amount of the liquid absorbed by the medical nursing pad to keep the medical nursing pad dry and comfortable.

These inversely funnelled SAP absorption regions are mutually independent. The density of the diversion region without the dotted SAP on the fluff pulp fibre is controlled within a certain range, and that is, the fluff pulp fibre is not compacted completely, and can form an air channel. Vapour reaches the bottom of the medical nursing pad through the air channel, and is expelled from the medical nursing pad through a composite breathable membrane, thereby achieving the purposes of keeping the medical nursing pad breathable and making it dry and comfortable.

A new core body layer of the present invention realizes the functions of rapidly diverting and retaining a liquid by controlling the density of a fluff pulp fibre region and distributing a dotted SAP on the fluff pulp fibre. After the liquid entering into the core body layer, the liquid can transversely spread within 360 degrees along the circumference to form an inversely funnelled absorption region. When the liquid spreads, the liquid is absorbed by the SAP in the core body layer. The core body layer can also be a double-layer core body layer. The use of the double-layer or multilayer core body layer can increase the transversely spreading speed of the liquid. Obviously, there is a gap between the core body layers, which can speed up the flow of the liquid and facilitate the absorption of the liquid by the SAP.

The present invention achieves the purpose of preventing bedsores by incorporating the two methods into the design of the medical nursing pad. The new core body layer of the present invention has a specific density. A vapour flow channel is longitudinally built in the core body layer under the specific density environment. Vapour can be expelled from the medical nursing pad through a composite breathable membrane.

Specifically, an embodiment of the present invention provides a medical nursing pad for preventing bedsores, comprising a surface layer, a core body layer and a bottom layer, characterized in that the core body layer comprises a fluff pulp and a super absorbent polymer material, and is covered by toilet paper. A dotted SAP (Super Absorbent Polymer) is distributed on the core body layer. The dotted SAP is inversely funnelled. The surface layer is composed of a soft hydrophilic spun-bonded nonwoven fabric. The bottom layer adopts a micro-porous breathable composite membrane. The SAP is applied onto the core body layer to form a plurality of inversely funnelled absorption regions. Each groove unit surrounded by multiple dotted SAPs serves as an absorption region. Adjacently distributed absorption regions can be connected to form an SAP-free fluff pulp fibre region functioning for diversion. A plurality of inversely funnelled diversion regions are formed relative to the absorption regions.

In the embodiment of the present invention, multiple dotted SAPs surround to form a hexagonal, octagonal, circular or polygonal combination.

In the embodiment of the present invention, a dotted SAP accumulation body is distributed hexagonally, wherein each dotted SAP material is shaped like a hexagon, six accumulation bodies composed of the dotted SAP material form a small SAP combination, and six small SAP combinations form a big SAP combination.

In the embodiment of the present invention, the dotted SAP is 1 mm to 3 mm in height, and 3 mm to 10 mm in diameter.

In the embodiment of the present invention, the density of the core body layer of the medical nursing pad ranges from 0.10 g/cc to 0.4 g/cc.

In the embodiment of the present invention, the gram weight of the toilet paper ranges from 12 g/m² to 28 g/m².

In the embodiment of the present invention, the core body layer is a single-layer core body layer, or a double-layer core body layer, or a multilayer core body layer.

In the embodiment of the present invention, the fluff pulp on the upper core body layer accounts for a larger percentage than that on the lower core body layer.

In the embodiment of the present invention, the SAP on the lower core body layer accounts for a larger percentage than that on the upper core body layer.

In the embodiment of the present invention, the absorption region occupies 5% to 30% the area of the core body layer.

In the embodiment of the present invention, the diversion region occupies 30% to 95% the area of the core body layer.

In the embodiment of the present invention, the gram weight of the spun-bonded nonwoven fabric ranges from 12 g/m² to 28 g/m².

In the embodiment of the present invention, the gram weight of the micro-porous breathable composite membrane ranges from 20 g/m² to 60 g/m².

In the embodiment of the present invention, the particle size of the SAP is 80 to 140 meshes.

In the embodiment of the present invention, the pH value of the SAP is 6 to 8.

Another one embodiment of the present invention further provides a method for fabricating the medical nursing pad for preventing bedsores, which has a dotted SAP applying method. The dotted SAP applying method has steps as follows. Use an SAP hopper to store SAP particle. Make the SAP particles fall to the outer surface of an SAP applying roller under the action of gravity. Make a conveyer belt mechanism drive a fluff pulp fibre to move forwards. When the fluff pulp fibre is moved forwards, make the SAP applying roller be rotated. Then, make SAPs contained in dotted SAP applying roller pits that are uniformly distributed on the outer surface of the SAP applying roller fall along with the rotation of the dotted SAP applying roller, and thus a dotted SAP pile is formed on the fluff pulp fibre. The SAP applying roller is a cylindrical roller made of stainless steel or alloy steel, the pits are uniformly arranged on the outer surface of the SAP applying roller, and the pits are used for storing the SAP in the SAP applying roller, and are made by laser engraving.

The present invention has the following advantages. The soft surface layer of the medical nursing pad adopts a nonwoven fabric where water can infiltrate rapidly, so that the liquid can abruptly reach the core body layer, thereby improving the dry performance of the surface of the medical nursing pad. The soft and breathable surface material improves the comfort level of the user, and achieves the dry and comfortable purpose. The core body layer of the medical nursing pad maintains the capacities of the medical nursing pad for storing and absorbing liquid and rapidly retaining water. The core body adopts dotted embossing to fix the core body structure, thus maintaining the integrity of the core body after vapour absorption. The bottom layer of the medical nursing pad is a composite breathable bottom membrane. A treated PE membrane and the nonwoven fabric are composited, and thousands of nanoscale breathable micro-pores are distributed on the thin membrane per square centimetre. The micro-pores have a special structure, which can not only prevent liquid leakage, but also help vapour molecules pass quickly, thereby realizing breathable and waterproof functions, and making the medical nursing pad drier and more conformable.

The present invention further comprises a device for applying a dotted SAP on a fluff pulp fibre. The device is a cylindrical applying roller. Funnelled pits are uniformly distributed on the outer surface of the applying roller. The pits can store the SAP. When the applying roller is rotated, the SAP in the pit falls onto the fluff pulp fibre that is moved forwards under the action of gravity, thus forming an inversely funnelled absorption region. As the funnelled pits on the applying roller are regularly distributed, funnelled absorption regions are also regularly distributed. The space between two adjacent funnelled absorption regions is controllable, but consideration must be given to both of the special liquid diversion and retaining channel features of the medical nursing pad. The absorption region occupies 5% to 30%, preferentially 15% to 20% the area of the core body layer. On the contrary, the diversion region occupies 30% to 95%, preferentially 80% to 85% the area of the core body layer. However, the area ratios of the absorption region and the diversion region to the core body layer are not constant. They need to be adjusted properly according to the application situation and operating condition of the medical nursing pad, but such adjustment is not the main part to be described in the present invention.

The present invention aims to develop a medical nursing pad for effectively preventing bedsores. An SAP is uniformly applied onto a fluff pulp fibre by an SAP applying device to form a plurality of dotted inversely funnelled absorption regions. A fluff pulp fibre not filled with the SAP in a core body layer of the medical nursing pad, having a major function of liquid diversion, forms a diversion region. A liquid spreads all around within 360 degrees in the diversion region after the liquid penetrates into the core body layer of the medical nursing pad. A transverse channel is formed in the core body layer. When the liquid flows into the inversely funnelled absorption region, it is rapidly absorbed and retained by the SAP in the absorption region. The density of the fluff pulp fibre in the diversion region is defined, that is, the fluff pulp fibre is not compacted completely. The incompletely compacted fluff pulp fibre can form an air channel inside. Vapour reaches the bottom of the medical nursing pad through the channel, and then is expelled from the medical nursing pad through a composite breathable membrane, thereby achieving the purpose of keeping the medical nursing pad breathable and making it dry and comfortable.

The density range of the fluff pulp fibre on the core body layer is controlled, and the dotted inversely funnelled SAP is applied onto the fluff pulp fibre by the SAP applying device to form a plurality of regularly arranged absorption regions to absorb and retain water. Consequently, the medical nursing pad of the present invention has the functions of retaining water and breathing. The materials of the surface layer, the core body layer and the bottom layer are optimized, so that the medical nursing pad of the present invention can provide a longitudinal vapour channel when transversely rapidly absorbing and firmly retaining water. Therefore, when a patient uses the medical nursing pad, the dry, comfortable and breathable nursing pad can keep his skin dry, breathable and comfortable, thereby preventing bedsores.

The present invention further comprises a device for applying an SAP onto a fluff pulp fibre, which is an SAP applying roller, wherein dotted funnelled pits that are uniformly and regularly distributed on the outer surface of the SAP applying roller are used for storing and applying SAP particles.

The medical nursing pad for preventing bedsores designed by the present invention is a product that can be put into industrial production. Any technician within the industry can complete the industrial production of the present invention on a nursing pad machine after making full understanding of the present invention.

Although the foregoing has described the present invention, it is not intended that the present invention be limited to details contained therein. Instead, various modifications may be made in various details within the scope and range of the equivalents of the claims, without departing from the spirit of the present invention. Those not mentioned in the specification are common knowledge of the art, and are not described in detail.

### BRIEF DESCRIPTION OF THE DRAWINGS

Hereinafter, embodiments of the present invention will be described in detail with reference to the accompanying drawings so that those skilled in the art to which the present invention pertains can realize the present invention.

FIG. 1 is a schematic diagram of a medical nursing pad according to an embodiment of the present invention.

FIG. 2 is a schematic diagram of a dotted SAP application according to an embodiment of the present invention.

FIG. 3 is a schematic diagram of pits on the outer surface of an SAP applying roller according to an embodiment of the present invention.

FIG. 4 is an enlarged schematic diagram of a pit on the outer surface of an SAP applying roller according to an embodiment of the present invention.

FIG. 5 is a schematic diagram of SAP distribution according to an embodiment of the present invention.

FIG. 6 is a schematic diagram of liquid spreading on a core body layer according to an embodiment of the present invention.

FIG. 7 is a schematic diagram of diversion of a double-layer core body layer according to an embodiment of the present invention.

FIG. 8 is a schematic diagram of diversion of a multilayer core body layer according to an embodiment of the present invention.

FIG. 9 is a structural schematic diagram of a micro-porous composite breathable membrane according to an embodiment of the present invention.

### DETAILED DESCRIPTION OF THE PREFERRED EMBODIMENTS

Hereinafter, embodiments of the present invention will be described in detail with reference to the accompanying drawings so that those skilled in the art to which the present invention pertains can realize the present invention. As those skilled in the art would realize, the described embodiments may be modified in various different ways, all without departing from the spirit or scope of the present invention.

It will be understood that, although the terms first, second, third, etc., may be used herein to describe various elements, these elements should not be limited by these terms. These terms are only used to distinguish one element from another element. Thus, a first element could be termed a second element without departing from the teachings of the invention.

In FIG. 1, according to a schematic figure of breathability of a medical nursing pad in an embodiment of the present invention, a liquid 14 infiltrates into a core body layer 12 from a spun-bonded nonwoven fabric 11. After the liquid 14 enters into the core body layer 12, the liquid 14 can transversely spread within 360 degrees along the circumference in the core body layer 12, and that is, the core body layer 12 forms a funnelled absorption region. When the liquid 14 spreads, the liquid 14 is absorbed and retained by a dotted SAP distributed in the core body layer 12. The water vapour 15 in the core body layer 12 is expelled through a longitudinal vapour channel reserved in the design of the core body layer 12 and by the breathable function of a composite breathable membrane on a bottom layer 13, thereby ensuring that the medical nursing pad is dry, comfortable and breathable, and achieving the purpose of preventing bedsores.

The following will describe the specific embodiments of the present invention in detail.

It is known that any medical nursing pad is composed of three parts, a surface layer, a core body layer and a bottom layer. For the medical nursing pad for preventing bedsores provided by the present invention, a core body layer is disposed between its surface layer and bottom layer, and the core body layer is composed of a fluff pulp fibre and an SAP, which are mixed and covered by toilet paper. The difference between the present invention and prior art is that, a dotted inversely funnelled SAP is applied onto the fluff pulp fibre in the core body layer by an SAP applying roller. Each dotted inversely funnelled SAP unit can be considered as an absorption region. Adjacently distributed absorption regions can be connected to form an SAP-free fluff pulp fibre region. The SAP-free fluff pulp fibre region is mainly composed of the fluff pulp fibre and plays a major role in diversion, and it is called a diversion region being inversely funnelled relative to the absorption region.

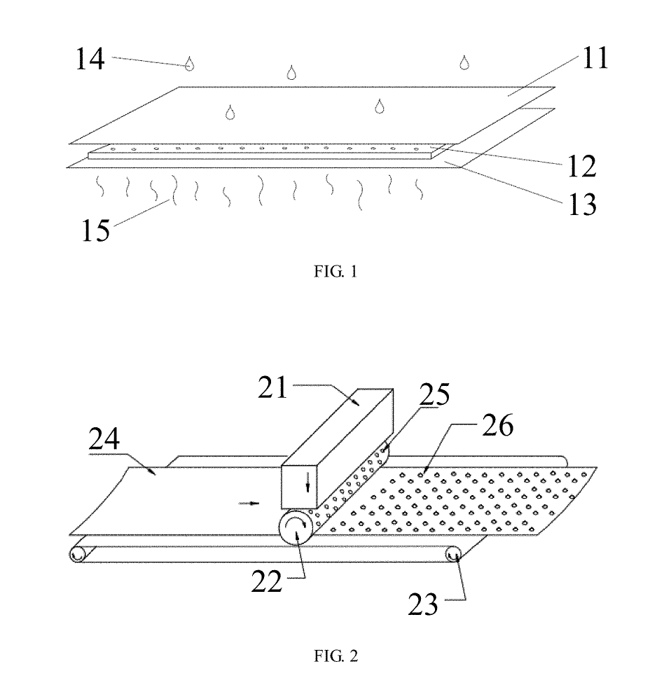

The application principles of the dotted inversely funnelled SAP are illustrated as follows. See FIG. 2, the dotted SAP application is shown. An SAP hopper 21 stores SAP particles, and the SAP particles fall to the outer surface of an SAP applying roller 22 under the action of gravity. A conveyer belt mechanism 23 drives a fluff pulp fibre 24 to move forwards. When the fluff pulp fibre 24 is moved forwards, the SAP applying roller 22 is rotated. Then SAPs contained in dotted funnelled SAP applying roller pits 25 that are uniformly distributed on the outer surface of the SAP applying roller 22 fall along with the rotation of the dotted SAP applying roller 22, and a dotted funnelled SAP 26 pile is formed on the fluff pulp fibre 24.

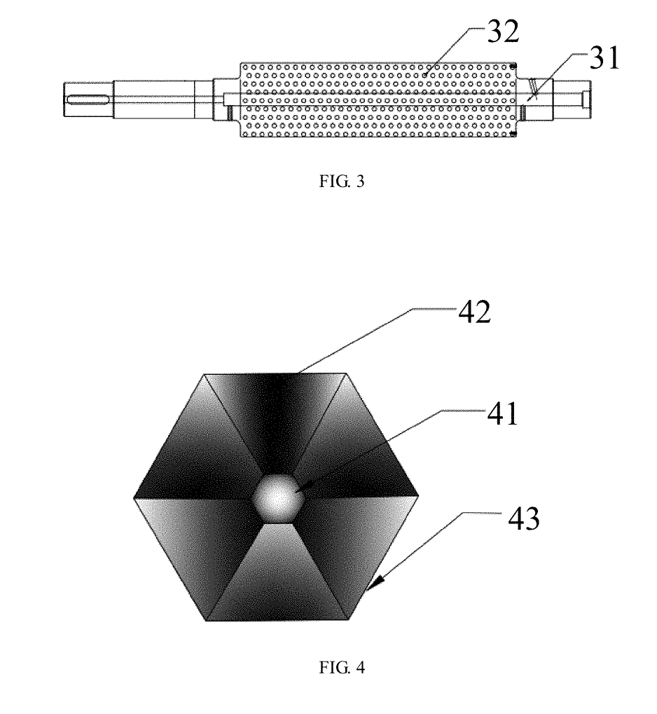

See FIG. 3, the SAP applying roller 31 is a cylindrical roller made of stainless steel or alloy steel, and the pits 32 are uniformly arranged on the outer surface of the SAP applying roller 31. The pits 32 are used for storing an SAP in the SAP applying roller 31, and are made with high dimensional accuracy and smooth surface by laser engraving. Meanwhile, with high hardness, the stainless steel or alloy steel is suitable for use under a long-wear condition.

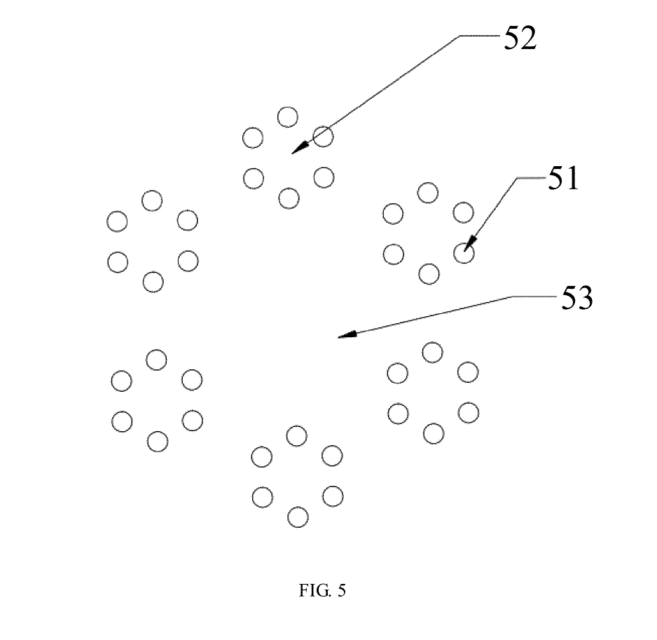

These pits can be better illustrated with reference in FIG. 4, which is the enlarged schematic diagram of a pit on the outer surface of an SAP applying roller, wherein a bottom surface 41 of the pit is located on the bottom of a side surface 42 of the pit, and an upper side 43 of the pit is above the side surface 42 of the pit. The pit can be of any equilateral or inequilateral shape, like hexagon, octagon or circle. It is recommended to be an equilateral hexagon as hexagon is more suitable for liquid diversion than other shapes, and a hexagonal SAP accumulation body can absorb the liquid more rapidly. The pit can be 1 mm to 3 mm in depth, and 3 mm to 10 mm in diameter. The SAP volume is determined according to the needed absorptive amount of the medical nursing pad. The present invention is not intended to be limited to a specific volume range, but only to suggest the depth and diameter range of the pit, and such pit form is intended to be protected by the present invention.

As hexagon is more suitable for liquid diversion than other shapes, the SAP accumulation body is also distributed hexagonally, as shown in FIG. 5, wherein an accumulation body made of an SAP material 51 can be distributed in a small hexagon, six accumulation bodies made of the SAP material 51 can form a small SAP combination 52, and six small combinations 52 of the SAP material can form a big SAP combination 53. The SAP distribution is reasonable, but combinations of other shapes can also be adopted. The hexagonal combination of the present invention does not imply that the present invention may not include combinations of other shapes.

The absorption region occupies 5% to 30%, preferentially 15% to 20% the area of the core body layer. On the contrary, the diversion region occupies 30% to 95%, preferentially 80% to 85% the area of the core body layer. The significance of this definition is clear. Any product serves the society more effectively only when their industrial production is realized. What is the most important is a high performance cost ratio, which shows tangible benefits to consumers and enables them to be able to afford and feel relieved to use. Therefore, the design of the medical nursing pad shall make full consideration of the affordability of consumers, and the designers must primarily consider a lower product cost under the prerequisite of ensured product functions. The use of the combination of the pits, especially the hexagonal combination of the pits, meets these requirements. The pits and their combination design are most satisfactory to product functions, and minimize the manufacturing cost of the product.

It is known that, the fluff pulp is a principal part of the core body layer of the medical nursing pad. The fluff pulp fibres composing the core body layer of the medical nursing pad are irregularly transversely arranged. When the density of the core body layer of the medical nursing pad is within a certain range, there are a plurality of gaps among the irregularly arranged fluff pulp fibres, which can provide a longitudinal channel for water and water vapour. It is understandable that when the density of the core body layer of the medical nursing pad is relatively large, and the channel among the fluff pulp fibres in the core body layer of the medical nursing pad is narrowed. On the contrary, when the density of the core body layer of the medical nursing pad is relatively small, the channel among the fluff pulp fibres in the core body layer of the medical nursing pad is widened, water and vapour can smoothly pass through the gaps of the fluff pulp fibres and reach the bottom of the core body layer of the medical nursing pad close to the micro-porous composite breathable membrane, and the vapour can be expelled through the micro-porous composite breathable membrane. As for the medical nursing pad for preventing bedsores provided by the present invention, as shown above, the density of the core body layer of the medical nursing pad is an important indicator of the present invention. When the density of the core body layer of the medical nursing pad is within a certain range, the out-of-order fluff pulp fibres can build a plurality of gaps and form a vapour channel for water vapour.

As for the medical nursing pad for preventing bedsores provided by the present invention, the density of the fluff pulp fibres in the core body layer is an important indicator of the present invention. If the density of the fluff pulp fibres in the core body layer of the medical nursing pad is small, the absorption speed and total absorptive amount of the liquid can be improved, but the spreading speed of the liquid will be reduced and the reverse osmosis amount will be increased. If the density of the fluff pulp fibres in the core body layer of the medical nursing pad is increased, the spreading of the liquid can be facilitated. The suitable density of the core body layer of the medical nursing pad of the present invention is determined to be 0.10 g/cc to 0.4 g/cc, preferentially, 0.15 g/cc to 0.25 g/cc. The medical nursing pad with such density range can ensure the building of the vapour channel in the medical nursing pad product while maintaining the capacities of liquid absorption and storage as well as rapid water retaining. Thus, it is conducive for the passing and expelling of the water vapour from the medical nursing pad to keep the medical nursing pad dry, comfortable and breathable, and the friction between the product and the skin can be reduced to make the user comfortable, thereby achieving the purpose of the present invention for preventing bedsores.

The fluff pulp fibres are wood pulp or straw pulp treated by bleaching and removing organic solvents, and so on. Alternatively, the fluff pulp fibres are paper pulp used as a water absorbing medium for the production of various sanitary products (for example, sanitary towels, baby diapers and mattresses of hospital, etc.). Compared with ordinary pulp sheets, a fluff pulp sheet has longer fibres and larger fibre strength, and is likely to be kneaded into filaments on a napping machine during the production of fluff pulp products like sanitary towels, with less dust caused during processing and fluffing. The fluff pulp products are good for water absorption and rapid for spreading, and the fluff pulp fibres have high whiteness, softness, certain elasticity and better core and pad integrity, and are compliant with specified hygienic indexes. After being bleached, the fluff pulp fibres have softness, high filling power, coarse and long fibres, low fines content, good integrity, even reticular fibres, and high adhesive force to the SAP. They have good vapour absorption time, speed and amount under proper density conditions.

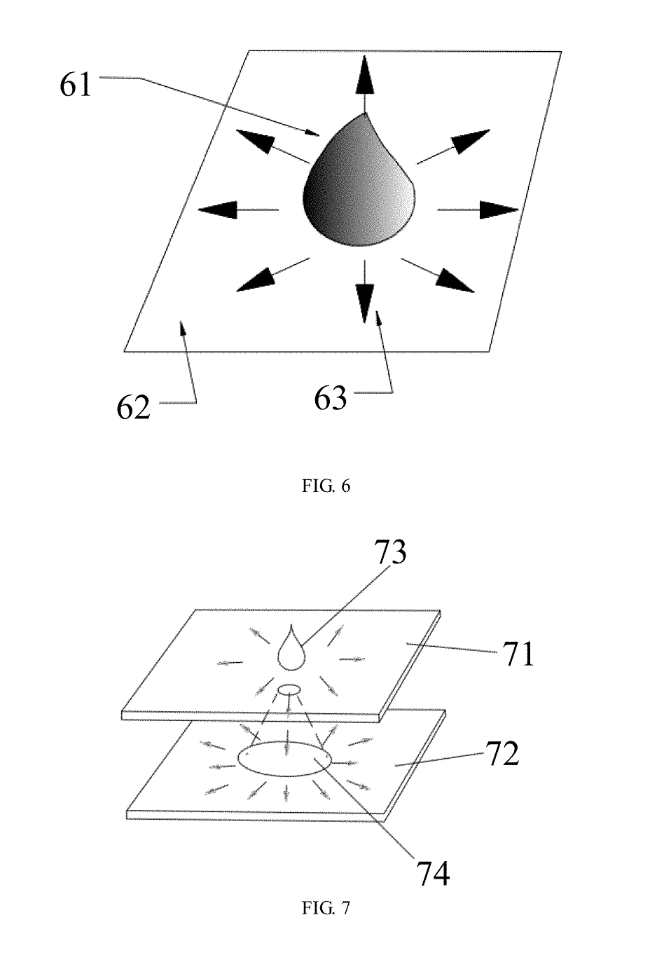

With even length, good integrity and well designed density, the irregularly transversely arranged fluff pulp fibres form an efficient diversion region, and the liquid rapidly transversely spreads all around within 360 degrees in the core body layer, and is absorbed and retained by the SAP in the inversely funnelled absorption region. Thus, the medical nursing pad realizes the function of rapidly absorbing and firmly retaining water. With such design, the medical nursing pad minimizes the reverse osmosis amount after absorbing the liquid, and the liquid can transversely spread within 360 degrees along the circumference after entering into the core body layer. See FIG. 6, FIG. 6 shows the liquid spreading on a core body layer. After a water drop 63 enters into the medical nursing pad, it is diverted by the fluff pulp 61 to transversely spread within 360 degrees. The spreading liquid is absorbed and retained by the SAP 62 in the core body layer, and the vapour in the medical nursing pad longitudinally infiltrates along the medical nursing pad until it reaches the micro-porous breathable composite membrane. The vapour is then expelled from the medical nursing pad through the micro-pores on the micro-porous breathable composite membrane. During the process, an inversely funnelled absorption region is formed, which is a characteristic of the product of the present invention.

A double-layer core body layer absorbs more quickly, as described in detail below. For example, the core body layer can be a double-layer core body layer. See FIG. 7, the use of a double-layer core body layer can speed up the transverse spreading of the liquid. The double-layer core body layer can be provided with a fluff pulp and an SAP with different proportions. An upper core body layer 71 can properly increase the fluff pulp proportion to realize a major function of diverting water 73, and a lower core body layer 72 can properly increase the SAP proportion to realize a major function of absorbing and retaining water 74. Obviously, a funnelled absorption region is formed on the double-layer core body layer after the core body layer is disposed. It has the positive effects of enabling water to spread rapidly and rapidly absorbing and retaining liquid, and besides, the funnelled shape can minimize the reverse osmosis amount of the liquid, thereby achieving the purpose of keeping the medical nursing pad dry and comfortable.

It is understandable that the present invention can be a single-layer core body layer, a double-layer core body layer or even a multilayer core body layer. The larger the number of layers, the better the dryness and comfort of the product, but any of these core body layers shall fall within the protection scope of the present invention.

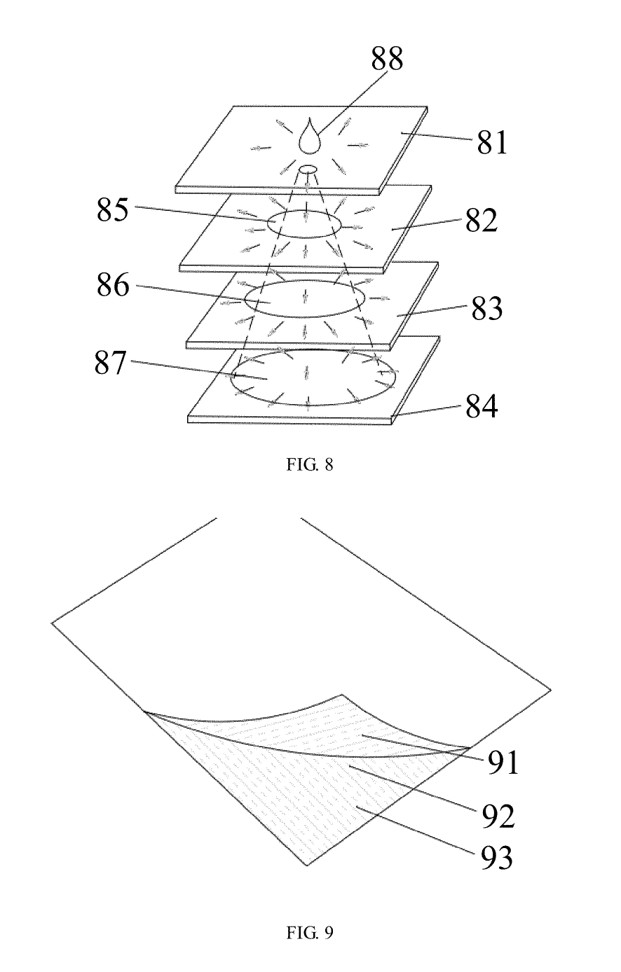

See FIG. 8, take a four-layer core body layer as an example, a multilayer core body layer can better speed up the transverse spreading of the liquid. The multilayer core body layer can be provided with a fluff pulp and an SAP with different proportions. A first core body layer 81 can properly increase the fluff pulp proportion to realize a major function of rapidly diverting water 88. A second core body layer 82 can properly increase the SAP proportion to realize a major function of absorbing and retaining water 85 while diverting. A third core body layer 83 can continuously increase the SAP proportion to realize a major function of substantially absorbing and retaining water 86 while slowly diverting. A fourth core body layer 84 is basically made of an SAP material, and has a major function of absorbing and retaining water 87. Obviously, a funnelled absorption region is formed on the multilayer core body layer after the core body layer is disposed. It has the positive effects of enabling water to spread rapidly and rapidly absorbing and retaining liquid, and besides, the funnelled shape can minimize the reverse osmosis amount of the liquid, thereby achieving the purpose of keeping the medical nursing pad dry and comfortable.

As a high polymer absorbent material, the SAP can absorb water that is more than ten times of its weight. As the SAP has a strong water retention capacity, it is also known as a super water absorbent or super water retention agent, a low-crosslinked or partially-crystallized macromolecular polymer with many hydrophilic groups. It is mainly used as a raw material for sanitary towels and diapers in the health field, and it is well known in the industry that the SAP has a strong water retaining capacity.

The SAP of the present invention is 80 to 140 meshes in particle size and 6 to 8 in pH value. It is because that smaller SAP particles may have a negative impact on the absorption speed and reverse osmosis, and may block the vapour channel or gap of the medical nursing pad. According to the experimental data of the industry, the water absorption and retaining capacity of the SAP is the best when its particle size is 100 to 120 meshes, and the absorption speed is the largest when the pH value is 6 to 8. Therefore, the present invention adopts the SAP with a particle size of 80 to 140 meshes to keep the vapour channel smooth in the core body layer of the medial nursing pad without being blocked by the SAP, thereby achieving the purpose of optimal water retaining.

It is well known in the industry that a medical nursing pad has a requirement for a pH value, and that is, urine and sweat from a patient can be effectively neutralized. Meanwhile, it is widely understood that an object of neutral pH value is more comfortable to human skin when it touches the human body.

The fluff pulp and the SAP in the core body layer of the present invention are covered by toilet paper. It is because the covering toilet paper can reduce the friction between the product and the skin, and facilitate the high speed industrial production of the medical nursing pad, and the toilet paper with good breathability will not impair the breathability of the medical nursing pad of the present invention. The gram weight of the toilet paper selected by the present invention ranges from 12 g/m² to 28 g/m², preferentially from 17 g/m² to 21 g/m².

The core body layer of the present invention adopts dotted embossing, which is designed to fix the core body structure, and maintain the integrity of the core body after vapour absorption. The dotted embossing may be in the form of a pattern, a text, or a combination of both, within the permitted scope of the present invention.

From the above, the present invention adopts soft fluff fibres with high filling power. The soft fluff fibres are coarse and long fibres. The SAP with a particle size of 80 to 140 meshes is added into the fluff pulp fibres with a density of 0.10 g/cc to 0.4 g/cc, thus building a vapour channel in the core body layer of the medical nursing pad. The water vapour in the medical nursing pad is expelled from the medical nursing pad through the micro-porous breathable composite membrane via the vapour channel, thereby maintaining the water retaining and breathable functions of the medical nursing pad of the present invention, and achieving the purpose of preventing bedsores.

The medical nursing pad of the present invention is composed of a surface layer, a bottom layer and a core body layer between the surface layer and the bottom layer. The absorption rate of the medical nursing pad of the present invention is not greater than 300 s, and the reverse osmosis amount is not greater than 15 g, which is necessary for the special liquid storage and absorption and rapid water retaining capacities of the medical nursing pad of the present invention.

The medical nursing pad for preventing bedsores provided by the present invention may further comprise the following contents.

In the medical nursing pad for preventing bedsores, a surface layer is composed of a soft nonwoven fabric, which has a function of enabling absorbed water to infiltrate quickly. To realize the function, the present invention adopts a hydrophilic spun-bonded nonwoven fabric, which is made by laying continuous filaments that come from extruded and stretched polymers into a web and treating the fibre web by self-bonding, heat bonding, chemical bonding or mechanical strengthening.

The hydrophilic spun-bonded nonwoven fabric is produced by adding a hydrophilic agent in the production process of the nonwoven fabric or adding it onto a fibre during fibre production. The hydrophilic agent is added as the fibre or nonwoven fabric composed of macromolecular polymers has few or non-hydrophilic groups and cannot provide necessary hydrophilic performance for nonwoven fabric application. The hydrophilic nonwoven fabric features a certain water absorption capacity, and is largely applied to medical products and sanitary care articles. The hydrophilic nonwoven fabric can rapidly transfer the liquid into the core body layer, and features small friction, high resistance to elevated temperatures, aging resistance, UV resistance, high elongation, good stability and breathability, resistance to corrosion, noise and moth, and non-toxicity. It can not only ensure the breathability of the present invention, but also be corrosion-resistant and non-toxic, thereby realizing the dry, comfortable and breathable performance of the product of the present invention, and meeting the requirements of keeping the skin clean and comfortable, etc. Besides, as the hydrophilic nonwoven fabric has the function of enabling water to rapidly infiltrate, the liquid can abruptly reach the core body layer of the medical nursing pad, thus keeping the surface of the medical nursing pad dry and comfortable. Therefore, the spun-bonded nonwoven fabric adopted by the present invention is soft, dry, comfortable and small in friction, and can greatly improve the comfort of the patient using it.

According to the operating requirements of the present invention, the gram weight of the hydrophilic spun-bonded nonwoven fabric ranges from 12 g/m² to 28 g/m², preferentially from 17 g/m² to 21 g/m². The gram weight range is selected according to the operating requirements of the medical nursing pad of the present invention. Within the gram weight range, the medical nursing pad of the present invention can keep good dry, comfortable, breathable and small friction features, thus achieving the purpose of being comfortable to the patient using it.

In a medical nursing pad for preventing bedsores provided by the present invention, a bottom layer adopts a micro-porous composite breathable membrane. The micro-porous composite breathable membrane is a new material. Due to the unique breathable performance of the micro-porous composite breathable membrane, water vapour can be rapidly expelled from the medical nursing pad to prevent the thriving of bacteria in the medical nursing pad. Therefore, it is a healthy and environment-friendly new material.

The micro-porous composite breathable membrane is also known as a “waterproof breathable micro-porous composite membrane”, having breathable and watertight features. It is composed of two materials, an upper micro-porous breathable membrane and a lower water-repellent spun-bonded nonwoven fabric, as shown in FIG. 9. A hot melt glue 92 between the micro-porous breathable membrane 91 and the water-repellent spun-bonded nonwoven fabric 93 glues the two materials to form the waterproof breathable micro-porous composite membrane.

The micro-porous composite breathable membrane is so disposed to maintain its breathable and watertight features and improve the friction of the bottom membrane as well as the tensile strength of the bottom layer of the medical nursing pad.

The upper layer of the micro-porous composite breathable membrane is the micro-porous breathable membrane. The upper layer has a lot of interconnected micro-pores. The diameter of the micro-pores is very small (about 0.01 to 10 μm), which is accessible to only water vapour molecules having a particle size of about 0.4 nm, and is too large for any liquid or water drops to pass through. In this way, the water vapour from the medical nursing pad can effectively spread outwards through the micro-pore diameter while the water drops cannot infiltrate, thus achieving the waterproof and vapour-breathable effects.

The micro-porous breathable membrane has the following principles. PE is used as a substrate, PE+CaCO3+ is used as an additive, and an inorganic filler (such as colour master batch, anti-oxygen, calcium carbonate and talcum powder) is added into the raw material. During the stretching process, the junction of the inorganic filler particles (1 to 10 μm) and the plastic film substrate under shaping is melt and extruded to form micro-pores. The micro-pores build an air channel, which realizes the breathable and watertight performance of the thin membrane.

According to the above principles, after the micro-porous composite breathable membrane is treated in that way, thousands of nanoscale breathable micro-pores are distributed on the thin membrane per square centimetre. The micro-pores have a special structure, which can not only prevent liquid leakage, but also help water vapour molecules pass quickly, thereby realizing the breathable and waterproof functions, and making the skin of a patient using the medical nursing pad dry and conformable.

The lower layer of the micro-porous composite breathable membrane is the water-repellent spun-bonded nonwoven fabric. The water-repellent principles of the water-repellent spun-bonded nonwoven fabric lie in a finishing agent with low surface tension, with which the surface tension of the nonwoven fabric is far lower than that of water. Thus, the surface of the nonwoven fabric has a water-repellent effect, and the nonwoven fabric can continuously maintain good breathability. A necessary condition for the water-repellent spun-bonded nonwoven fabric to realize its water-repellent performance is that the critical surface tension of the nonwoven fabric material is less than the surface tension of the liquid (for example, water and urine, etc.). The technological process is: preparing a finishing working liquid→treating the nonwoven fabric by the finishing liquid→drying→curing→water-repelling material. The finishing liquid may be paraffin, organic silicon or fluorine-containing resins.

Specifically, the spun-bonded nonwoven fabric adopted by the present invention has an important role of improving the friction of the micro-porous composite breathable membrane as the friction of the spun-bonded nonwoven fabric is far greater than the PE membrane and the composited micro-porous breathable membrane has much higher tensile strength than a single-layer micro-porous breathable membrane. The spun-bonded melt-blown (SMS and SMMS) water-repellent nonwoven fabric features low gram weight, high strength and extension, high breathability, and strong water repellence. The product has good evenness and high opaqueness. The spun-bonded layer is composed of continuous filaments, and has good breaking strength and elongation; the melt-blown layer is composed of continuous superfine fibres, and has a good shielding effect for water, bacteria and dust, and so on. The nonwoven fabric has very high resistance to water pressure, good breathability and good acid and alkali resistance, and can display different colours. The nonwoven fabric can be used for operating coats, surgical drapes, wound care, protective garments, caps and masks in the medical industry, and can also be used for the side leakage prevention edges of baby and adult diapers in the health field. It is also commonly known in the industry, and will not be described in detail herein.

The composited upper micro-porous breathable membrane and lower water-repellent spun-bonded nonwoven fabric of the micro-porous composite breathable membrane have already been disclosed in the industry. A more advanced technology for compositing the two materials on line has also been disclosed in the industry. For example, the technology has been described in detail in the “Composite Bottom Membrane Applying Device for Disposable Absorptive Product Nursing Pad” in a patent CN103832043A, and will not be described herein.

The disposable medical nursing pad of the present invention is produced by using the micro-porous breathable composite membrane. It has special performance, such as excellent leakage prevention performance and breathability, high tensile strength, and comfort and softness, and is free from the waxy feel of ordinary cast films.

According to the operating requirements of the present invention, the gram weight of the micro-porous breathable composite membrane on the bottom layer of the medical nursing pad ranges from 20 g/m² to 60 g/m², preferentially from 32 g/m² to 48 g/m². The gram weight range is selected according to the operating requirements of the medical nursing pad. Within the gram weight range, the micro-porous breathable composite membrane of the medical nursing pad of the present invention can realize a water vapour transmission rate (WVTR) not less than 1600 g/m²*24 h, which meets the breathability requirement of the present invention for effectively preventing bedsores.

According to the ASTM E96 standard of the American Society for Testing and Materials (ASTM), formerly the International Association for Testing Materials (IATM), the water vapour transmission rate refers to the total amount of water vapour that transmits through a sample per unit time per unit area, wherein the transmission direction is vertical to a certain surface of the sample. All the surfaces of the sample have certain temperature and humidity. A common unit is g/m²*24 h.

The medical nursing pad for effectively preventing bedsores in the present invention adopts a breathability test method, namely a water vapour inverted cup method, which is a method for testing the breathability of the medical nursing pad according to the ASTM E96 standard of the American Society for Testing and Materials, as follows.

The test principles comprise: covering a vapour-breathable cup filled with distilled water with a tested fabric, fixing and then inverting the cup, weighing the cup with a top loading balance with the accuracy of 0.001 g, and emplacing it in a position in a bleed wind tunnel; recording the ambient temperature and relative humidity before weighing the cup in an environmental chamber with temperature of 23° C., relative humidity of 50% and air speed of 2.5 m/s; recoding both the cup weight and weighing time; recording the weight at the time of 3 h, 6 h, 9 h, 13 h, 23 h, 26 h and 30 h, and calculating the water vapour transmission rate according to the formula of WVT=24*Δm/(s*t); using the mean value of the six samples as a test result, and multiplying the mean value by 24 to form a result in the unit of g/m2*24 h.

Further, there is a simple test method, using about 80° C. of hot water as a reagent and four transparent glass cups as instruments, and comprising the following steps: 1. preparing four identical transparent glass cups, and fully filling two of them with hot water; 2. respectively emplacing the two hot water glass cups beneath the medical nursing pad of the present invention and a different medical nursing pad, wherein the bottom layers of the medical nursing pads are upturned, and finally respectively covering them with the dry glass cups; 3. after letting them stand for 5 min, it can be seen that if the product is breathable, there is water vapour reaching the surface layer of the medical nursing pad and condensing into water drops on the wall of the cup, and if the product is not breathable, there are no water drops.

While the means of specific embodiments in present invention has been described by reference drawings, numerous modifications and variations could be made thereto by those skilled in the art without departing from the scope and spirit of the invention set forth in the claims. The modifications and variations should in a range limited by the specification of the present invention.

What is claimed is:

1. A medical nursing pad for preventing bedsores, comprising:
a surface layer, composed of a soft hydrophilic spun-bonded nonwoven fabric;
a core body layer, comprising a fluff pulp and a super absorbent polymer material, and is covered by toilet paper; and
a bottom layer, adopting a micro-porous breathable composite membrane;
wherein a dotted SAP (Super Absorbent Polymer) is inversely funnelled, distributed on the core body layer, and applied onto the core body layer to form a plurality of inversely funnelled absorption regions, each of groove units surrounded by multiple dotted SAPs serves as an absorption region, adjacently distributed absorption regions are connected to form an SAP-free fluff pulp fibre region functioning for diversion, and a plurality of inversely funnelled diversion regions are formed relative to the absorption regions.

2. The medical nursing pad for preventing bedsores according to claim 1, wherein the dotted SAPs surround to form a hexagonal, octagonal, circular or polygonal combination.

3. The medical nursing pad for preventing bedsores according to claim 2, wherein a dotted SAP accumulation body is distributed hexagonally, wherein each dotted SAP material is shaped like a hexagon, six accumulation bodies composed of the dotted SAP material form a small SAP combination, and six small SAP combinations form a big SAP combination.

4. The medical nursing pad for preventing bedsores according to claim 3, wherein the dotted SAP is 1 mm to 3 mm in height, and 3 mm to 10 mm in diameter.

5. The medical nursing pad for preventing bedsores according to claim 4, wherein the density of the core body layer of the medical nursing pad ranges from 0.10 g/cc to 0.4 g/cc.

6. The medical nursing pad for preventing bedsores according to claim 5, characterized in that the gram weight of the toilet paper ranges from 12 g/m² to 28 g/m².

7. The medical nursing pad for preventing bedsores according to claim 6, wherein the core body layer is a single-layer core body layer, or a double-layer core body layer, or a multilayer core body layer.

8. The medical nursing pad for preventing bedsores according to claim 7, wherein the fluff pulp on the upper core body layer accounts for a larger percentage than that on the lower core body layer.

9. The medical nursing pad for preventing bedsores according to claim 8, wherein the SAP on the lower core body layer accounts for a larger percentage than that on the upper core body layer.

10. The medical nursing pad for preventing bedsores according to claim 9, wherein the absorption region occupies 5% to 30% the area of the core body layer.

11. The medical nursing pad for preventing bedsores according to claim 10, wherein the diversion region occupies 30% to 95% the area of the core body layer.

12. The medical nursing pad for preventing bedsores according to claim 11, wherein the gram weight of the spun-bonded nonwoven fabric ranges from 12 g/m² to 28 g/m².

13. The medical nursing pad for preventing bedsores according to claim 12, wherein the gram weight of the micro-porous breathable composite membrane ranges from 20 g/m² to 60 g/m².

14. The medical nursing pad for preventing bedsores according to claim 13, wherein the particle size of the SAP is 80 to 140 meshes.

15. The medical nursing pad for preventing bedsores according to claim 14, wherein the pH value of the SAP is 6 to 8.

16. A method for fabricating the medical nursing pad for preventing bedsores according to claim 1, comprising a dotted SAP applying method, and the dotted SAP applying method comprises:
using an SAP hopper stores SAP particles;
making the SAP particles fall to the outer surface of an SAP applying roller under the action of gravity;
using a conveyer belt mechanism to drive a fluff pulp fibre to move forwards;
when the fluff pulp fibre is moved forwards, rotating the SAP applying roller; and
making SAPs contained in dotted SAP applying roller pits that are uniformly distributed on the outer surface of the SAP applying roller fall along with the rotation of the dotted SAP applying roller, and thus a dotted SAP pile is formed on the fluff pulp fibre;
wherein the SAP applying roller is a cylindrical roller made of stainless steel or alloy steel, the pits are uniformly arranged on the outer surface of the SAP applying roller, and the pits are used for storing the SAP in the SAP applying roller, and are made by laser engraving.
